(19) United States
(12) Patent Application Publication
(10) Pub. No.: US 2006/0174542 A1
(43) Pub. Date: Aug. 10, 2006

(54) Deflection device for a motor vehicle window lift

(76) Inventors: Pierre-Dominique Bernard, Untermerzbach (DE); Frank Fabbender, Coburg (DE); Uwe Klippert, Oberaula (DE)

Correspondence Address: CHRISTIE, PARKER & HALE, LLP, PO BOX 7068, PASADENA, CA, 91109-7068, US

(21) Appl. No.: 10/562,258

(22) PCT Filed: Jun. 8, 2004
(86) PCT No.: PCT/DE04/01188

§ 371 Date: Dec. 21, 2005

(30) Foreign Application Priority Data
Jun. 25, 2003 (DE) 203 10 038.7

(51) Int. Cl. E05F 11/48

(52) U.S. Cl. 49/352

(57) ABSTRACT

A deflection device for a motor vehicle window lift comprises a deflection element for deflecting a traction means pertaining to said window lift and spring means for tightening the traction means. The deflection element is moveably mounted on a receiving element and can be placed in a plurality of different positions on the receiving element by the spring means arranged on the receiving element. The receiving element, deflection element and spring means are fixable to the window lift in the form of a pre-mounted module.

### CROSS-REFERENCE TO A RELATED APPLICATION

This application is a National Phase Patent Application of International Application Number PCT/DE2004/001188, filed on Jun. 8, 2004, which claims priority of German Utility Model Number 203 10 038.7, filed on Jun. 25, 2003.

### BACKGROUND

The invention relates to a deflection device for a motor vehicle window lifter. A deflection device of this kind comprises a deflection element for deflecting a traction the window lifter as well as spring means for tensioning the traction means in order to compensate for any lengthening of the traction means.

The deflection element can be for example a cable pulley by which a traction a window lifter in the form of a drive cable is deflected in order to guide the drive cable along the displacement direction of the window pane which is to be adjusted with the window lifter. The traction means or drive cable serves to couple the window pane which is to be adjusted to the drive device of the window lifter and is moved through same. By connecting the window pane to the drive cable through a follower it is entrained along its extension direction as the drive cable is moved. A drive cable which is guided along the displacement direction of the window pane which is to be adjusted therefore causes the desired adjusting movement of the window pane when the drive of the window lifter is activated.

As a result of the settlement behaviour of the vehicle components, more particularly plastics components (which are under tension) to which the window lifter is fixed, after a longer operation there is a noticeable (relative) lengthening of the traction means or drive cable (forming a so-called cable slack) relative to the said vehicle components which has to be compensated so that the traction means is further defined and guided taut along the displacement direction of the window pane which is to be displaced thereby transferring the forces generated by the window lifter drive to the window pane. Furthermore as a result of the considerable traction forces which during actuation of the window lifter act on the traction means or drive cable a certain direct lengthening of the traction means itself can take place.

It is known in order to maintain the tension of the traction means to use pretensioned spring means which engage on a movably mounted deflection element of the window lifter and have the tendency to move this or to swivel same so that the traction means is tightened by the displacement of the deflection element.

The invention is concerned with the problem of further improving the deflection device of the type mentioned at the beginning.

### BRIEF DESCRIPTION

According to this it is proposed that the deflection element is mounted movable on a socket and in order to compensate lengthening of the traction means can be brought into a number of different positions through spring means mounted on the socket whereby the socket can be fixed together with the deflection element and spring means as one pre-assembled structural module on the window lifter.

By window lifter is thereby meant here not only the drive the window lifter, such as e.g. a drive motor, a gearing provided to couple the drive motor to the traction means, a follower for the window pane etc, but also the structural modules supporting the window lifter, such as e.g. a support element in the form of a support plate. The structural module prefitted on the socket is preferably fixed on the support element or on a guide device serving to guide the follower which is connected to the traction means.

By “lengthening” of the traction means is meant here not only a direct lengthening of the traction means itself but in general a relative change in the length of the traction means, in relation to the vehicle components (door components, such as e.g. a support plate of the window lifter), on which the window lifter is mounted, thus in particular also a noticeable lengthening of the traction means which is due to the settlement behaviour of any door component (on which for example the deflection elements are fixed for guiding the traction means).

The solution according to the invention has the advantage that all the components of a deflection device for a traction a window lifter which serves at the same time to compensate lengthening of the traction means, including the spring means required for this as well as the means for the movable positioning of the deflection element, can be preassembled as one separate structural unit which is then fixed as a fully pre-assembled unit to the window lifter. The flexibility is hereby further increased when assembling a window lifter.

According to a preferred embodiment of the invention the socket forms a housing on or in which the deflection device is movably positioned.

For the movable, more particularly, displaceable, or pivotal bearing of the deflection element on the socket a guideway can be provided there by which the deflection element is guided so that it can be brought into different positions which each induce a defined tightening of the traction means in order to compensate for any lengthening of the traction means.

For this the traction means is preferably mounted on a slider guided movable on the socket and which can be a separate part from the deflection element to which the deflection element is connected through suitable connecting means, e.g. through rivets. The connecting elements required for this can be provided on the deflection element, e.g. in the form of a stepped bolt which engages through an associated opening in the slider and whose end section projecting out from the opening and remote from the deflection element is turned over so that a positive connection is formed between deflection element and slider. Obviously the connecting means can also conversely be provided on the slider and engage through an associated opening in the deflection element.

According to a preferred further development of the invention a fixing device is provided in order to fix the deflection element or slider on the socket so long as the preassembled structural module is not yet mounted on the window lifter. For only after fitting the said deflection and compensation module on a window lifter and bringing the window lifter into operation is there to be any possible movement of the deflection element or slider in the socket in order to compensate lengthening of the traction means. In the preassembled state the corresponding components are however to be fixed as much as possible relative to each other in order to guarantee easy transport of the preassembled structural module.

The fixing device can be aligned and formed for example to produce a positive locking connection between the deflection element or slider and the socket, e.g. by a detent connection or by a securing pin.

In a preferred embodiment when bringing the window lifter into operation the fixing device can be automatically released through the action of the traction means on the deflection device so that then the deflection element or slider is movable in the socket. After unlocking the fixing device the deflection element or slider is held in its relevant balanced position through the interaction of the spring means and traction the window lifter.

Furthermore locking means are provided in order to lock the deflection element in its balanced position defined by the interaction of the spring means with the traction means; this can hereby be for example positive locking means in the form of interacting toothed regions.

One of the two toothed regions is thereby provided on the socket or on an insert part mounted in the socket and the other toothed region is provided on the slider. For a particularly finely tuned positioning of the deflection element on the socket the toothed regions can each be provided on one of two inclined planes set relative to each other.

During operation of the window lifter the locking means are locked through tensioning of the traction means so that the deflection element remains continuously in a predetermined position on the socket so long as the traction means are sufficiently tensioned. If during operation of the window lifter there is a lengthening of the traction means, i.e. a cable slack in the drive cable then as a result of the decreasing tension of the traction means an unlocking of the locking means can occur and the spring means provided to tighten the cable cause a displacement of the deflection element (through the associated slider), as a result of which the cable can be tensioned again and the deflection element can be locked in a new balanced position.

The deflection device according to the invention is particularly suitable for use in so-called path window lifters in which a number of guideways are integrated into a support for associated followers of the window lifter.

Special significance is placed on cable length compensation if the (path-controlled) window lifter is used in connection with a so-called short lift application for frameless window panes so that the window pane is temporarily lowered each time during opening and closing of the associated vehicle door. In this case the adjusting system, more particularly the cable is subject to very high loads which lead over the service life mostly to such cable lengthening that the short lift function and any possible anti-jamming protection provided can no longer be operated with sufficient reliability.

A window lifter, more particularly a path window lifter in which the deflection device is used.

### BRIEF DESCRIPTION OF THE DRAWINGS

Further features and advantages of the invention will be apparent from the following description of embodiments with reference to the drawings.

FIG. 1a is a section of a path window lifter with a deflection device mounted thereon and having a movably mounted deflection element for a traction the path window lifter which is displaceable to tighten the traction means.

FIG. 1b shows the arrangement of FIG. 1a after displacement of the deflection element.

FIG. 2a is a perspective view of the deflection device of FIGS. 1a and 1b.

FIG. 2b is an exploded view of the deflection device of FIGS. 1a and 1b.

FIG. 3a is a first sectional view of different positions for the deflection device of FIGS. 2a and 2b, namely in the preassembled state of the deflection device, after installation in a window lifter, with the appearance of cable slack and after compensating the cable slack.

FIG. 3b is a second sectional view of different positions for the deflection device of FIGS. 2a and 2b, namely in the preassembled state of the deflection device, after installation in a window lifter, with the appearance of cable slack and after compensating the cable slack.

FIG. 3c is a third sectional view of different positions for the deflection device of FIGS. 2a and 2b, namely in the preassembled state of the deflection device, after installation in a window lifter, with the appearance of cable slack and after compensating the cable slack.

FIG. 3d is a fourth sectional view of different positions for the deflection device of FIGS. 2a and 2b, namely in the preassembled state of the deflection device, after installation in a window lifter, with the appearance of cable slack and after compensating the cable slack.

FIG. 4 is a modification of the deflection device of FIGS. 3a and 3b for securing the deflection element in the preassembled state of the deflection device.

FIG. 4a is a further modification of the deflection device of FIGS. 2a and 2b before and after the compensation of the cable length.

FIG. 4b is a further modification of the deflection device of FIGS. 2a and 2b before and after the compensation of the cable length.

FIG. 5 is a cross-sectional view through the deflection device of FIGS. 4a and 4b after cable length compensation.

FIG. 6a is a further modification of the deflection device of FIGS. 2a and 2b before and after cable length compensation.

FIG. 6b is a further modification of the deflection device of FIGS. 2a and 2b before and after cable length compensation.

FIG. 7a is a first perspective view of the locking means for locking the deflection element of the deflection device of FIGS. 6a and 6b.

FIG. 7b is a second perspective view of the locking means for locking the deflection element of the deflection device of FIGS. 6a and 6b.

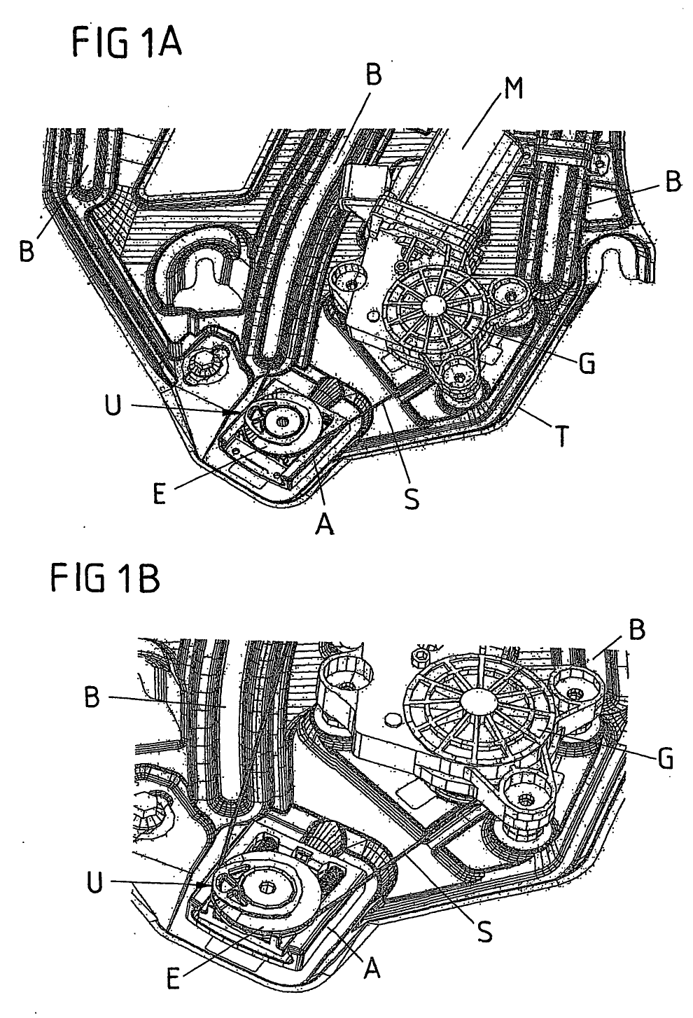

FIG. 1a shows a path window lifter with a drive motor M and with a gearing G on the output side of the drive motor M by which traction means in the form of a drive cable S of the window lifter is driven which in turn is deflected by a deflection element E in the form of a cable pulley of a deflection device U so that it extends along the guideways B of the path window lifter. The three guideways B run along the displacement direction of the window pane which is to be adjusted by the window lifter and serve for the displaceable mounting of a follower which on one side supports the window pane which is to be adjusted and which on the other side is connected to the drive cable S. Since the drive cable S is guided by the deflection element E of the deflection device U along the extension direction of the guideways B the follower which takes up the window pane can be moved through this drive cable along these guideways B during activation of the drive motor M in order to lift or lower the window pane which is connected thereto.

The deflection element E of the deflection device U is thereby mounted displaceable in a socket A which is fixed on the support element (support plate T) on which the guideways B are mounted (moulded integral therewith) and which moreover supports the drive means M, G of the window lifter.

FIG. 1b shows the arrangement of FIG. 1a after displacement of the deflection element E in the socket A which has led to tightening of the drive cable S to compensate for cable slack (induced through the settlement behaviour of the support plate T).

The tightening of a drive cable through movement of a deflection element of a window lifter is basically known. Therefore details will now only be provided for the special features of the current deflection device U which is characterised in particular in that it forms a structural unit which can be preassembled away from the window lifter and which combines the functions of a deflection of the drive cable S and cable length compensation (compensation of a cable slack).

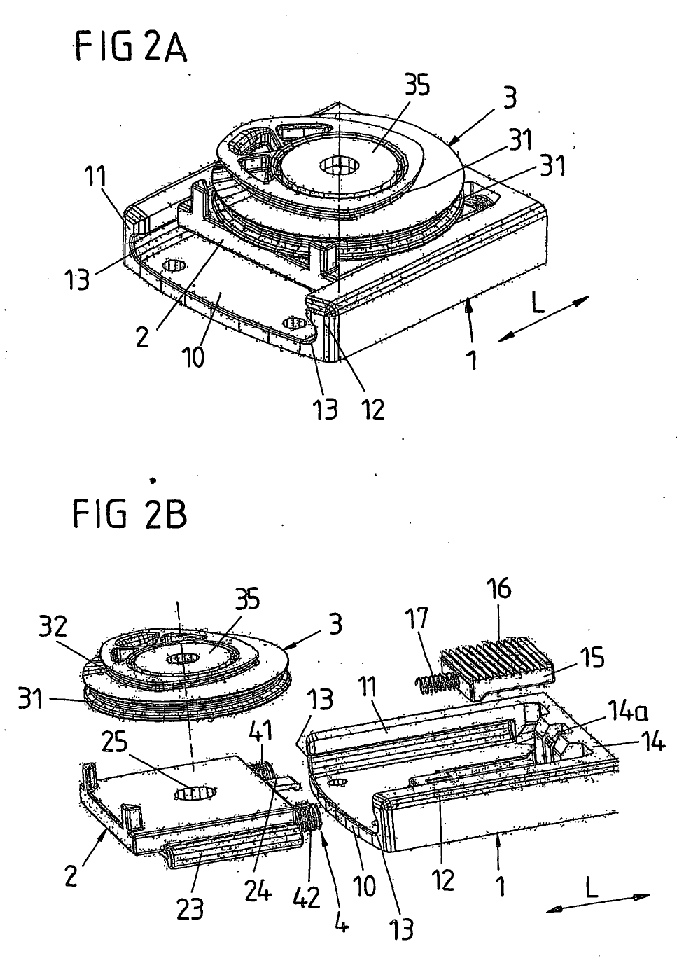

FIGS. 2a and 2b show the deflection device U of FIGS. 1a and 1b in a perspective view as well as in an exploded view. The deflection device comprises a housing-type socket 1 with a base surface 10 of which two inwardly angled arms 11, 12 protrude at right angles to define a longitudinal guide 13 which is defined by a back wall 14 of the socket 1 and extends along a longitudinal direction L for a slider 2 which engages in the longitudinal guide 13 by side guide and slide faces 23. The slider 2 is hereby mounted in the housing-type socket 1 displaceable along a longitudinal direction L which corresponds to the extension direction of the longitudinal guide 13.

The slider 2 has a through opening 25 on which a deflection element in the form of cable pulley 3 is fixed by a stepped bolt, the deflection element having a guide section 31 for the drive cable which is to be deflected and an assembly section 32 for transferring the drive cable to the guide section 31 during assembly of the window lifter.

In the assembled state of the window lifter, thus when the cable pulley 3 is looped round by the drive cable of the window lifter, the cable has as a result of the existing cable tension the tendency to press the cable pulley 3 together with the slider 2 against the back wall 24 of the socket 1. However this is counteracted by spring means 4 in the form of two pretensioned springs 41, 42 which are supported on one side on the back wall 14 of the socket 1 and on the other side on the slider 2 and which have the tendency to move the slider 2 away from the back wall 14 of the socket 1. It is hereby possible to compensate for the lengthening of the drive cable and to hold this in a constantly taut position.

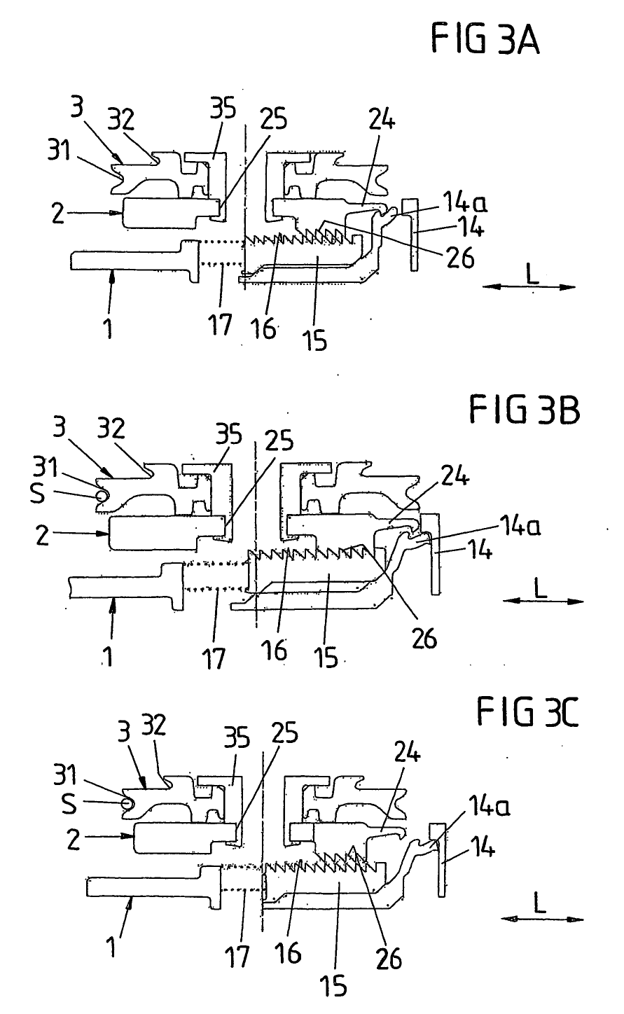

In order to be able to fix the slider 2 in certain longitudinal positions relative to the socket 1 an insert part 15 with longitudinal toothing 16 is mounted in the socket 1 and is held by a spring 17 in a defined position inside the socket 1. The toothing 16 of the insert part 15 is associated with a corresponding counter toothing of the slider 2 so that when the two toothing sets engage in each other the slider 2 is locked in a specific position inside the socket, as will be described in further detail below with reference to FIGS. 3a and 3b.

Furthermore a detent hook or clip 24 is mounted on the slider 2 and can engage in an associated detent or clip area 14a of the back wall 14 of the socket 1 so that in the preassembled state of the structural unit comprising the socket 1, the slider 2, the cable pulley 3 and the spring means 4, the slider 2 (and thus also the deflection device 3 and spring means 4) are fixed on the socket 1.

FIG. 3a shows a longitudinal section through the deflection device of FIGS. 2a and 2b in the preassembled state, i.e. prior to integration into a vehicle window lifter. It can be seen that the toothing 16 of the insert part 15 of the socket 1 on the one hand and the counter toothing 26 of the slider 2 on the other are not in engagement in this position and that the slider 2 is fixed in the socket through engagement of its detent or clip hook 24 in the detent or clip area 14a on the back wall 14 of the socket 1. It can further be seen that the stepped bolt 35 of the cable pulley 3 formed as a hollow body with axial through opening engages through the associated through opening 25 of the slider 2 and is turned at its free ends so that a force-locking and positive-locking connection is produced between the cable pulley 3 and slider 2.

In the position illustrated in FIG. 3a the structural unit consisting of the socket 1, slider 2, deflection element 3 and spring means 4 is fitted on the window lifter for example by screws or rivets and the drive cable S is brought onto the guide section 31 of the cable pulley 3. If now in the first operation of the finished mounted window lifter the follower (and thus the window pane which is to be displaced) is moved onto the lower stop of the window lifter then the drive cable S, see FIG. 3b, draws the slider 2 against the action of the spring means 4 towards the back wall 14 of the socket 1 whereby the teeth 16 of the insert part 15 and the associated counter teeth 26 of the slider 2 engage in each other and the detent and clip connection 14a, 24 become disengaged according to FIG. 3b. The slider 2 is hereby positioned in the socket 1 by the insert part 15 through a spring 17, and through the action of the interengaging teeth 16, 26 is locked in a defined longitudinal position inside the socket 1 namely in the closest position to the back wall 14 of the socket 1 which is possible within the interplay of the teeth 16,26.

If a cable slack occurs, thus lengthening of the drive cable S and a decrease in the cable tension, the two toothing sets 16, 26 move out of engagement and the slider 2 and thus also the cable pulley 3 move under the action of the spring means 4 (see FIGS. 2a and 2b) slightly away from the back wall 14 of the socket 1, corresponding to the illustration in FIG. 3c.

If finally the cable lengthening has occurred to such an extent that the longitudinal displacement of the slider 2 relative to the back wall 14 of the socket 1 corresponds to a tooth width then the two toothing sets 16, 26 move into engagement with each other again according to FIG. 3d so that the slider 2 and deflection element 3 are locked again in the defined position in the socket 1.

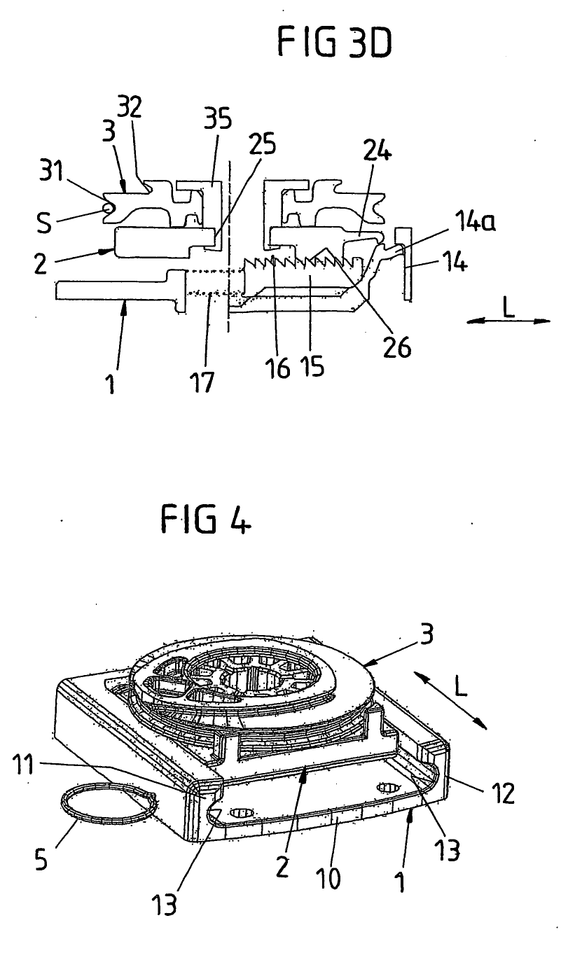

FIG. 4 shows a modification of the deflection devices of FIGS. 2a and 2b whereby the difference is that to pre-fix the slider 2 in the socket 1 a securing pin 5 is used in place of a clip or detent connection 14a, 24. This securing pin 5 which engages through associated openings in the socket 1 and slider 2 and fixes the latter in the socket 1 is removed after the structural unit is installed in a window lifter. Thus no automatic unlocking of the fixing device takes place, as opposed to the deflection device of FIGS. 2a and 2b.

FIG. 4a shows a further modification of the deflection device of FIGS. 2a and 2b whereby a difference lies in the design of the guide device by which the slider 2 is guided movable in the longitudinal direction L in the socket 1. For this the slider 2 has side guide projections 23′ which are guided in the associated longitudinal slits 13′ in the socket 1. Furthermore the spring means 4 are formed in the deflection device illustrated in FIG. 4a by a single pretensioned spring element 40.

FIG. 4b shows the deflection device of 4a after displacement of the cable pulley 3 under the action of the spring element 40 for compensating a lengthening of the drive cable S whereby the slider 2 was guided in the longitudinal guide 13′, 23′.

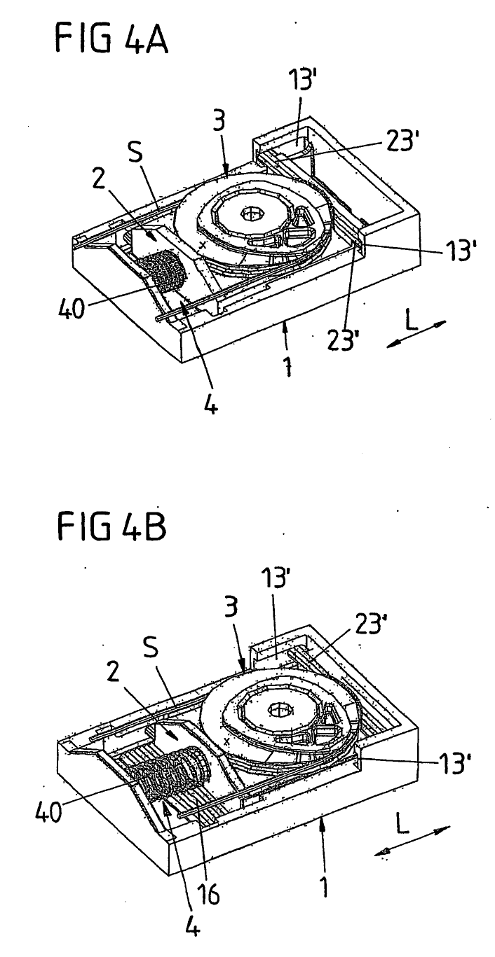

From comparing FIG. 4b with the longitudinal section of FIG. 5 it is thereby also clear that currently the toothed section 16 of the socket 1 is formed not on a separate insert part but directly on the base plate 10 of the socket 1. Furthermore the counter teeth of the slider 2 are only formed by a single toothed element.

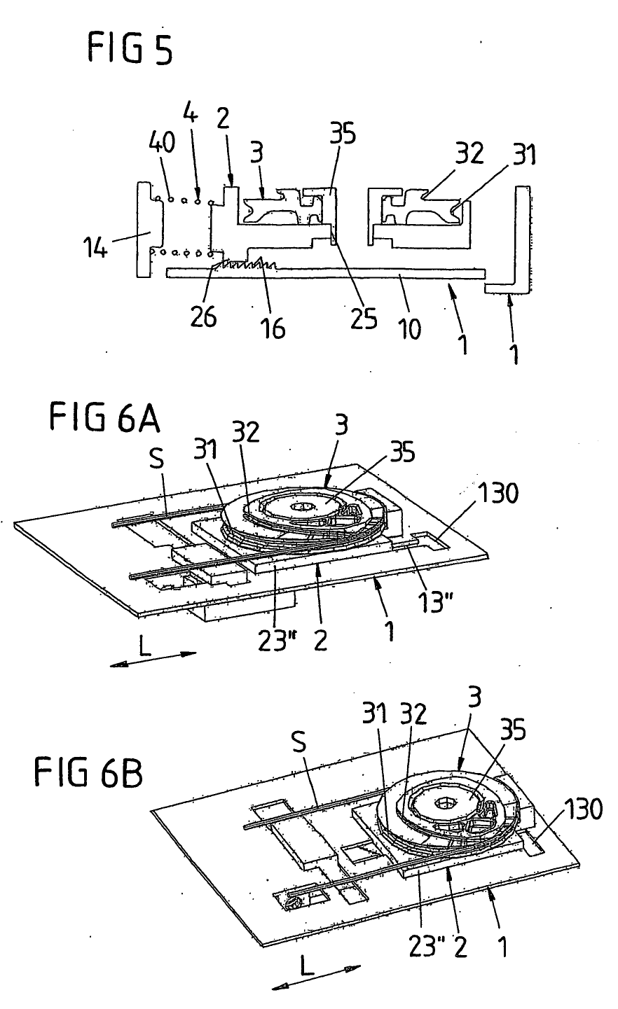

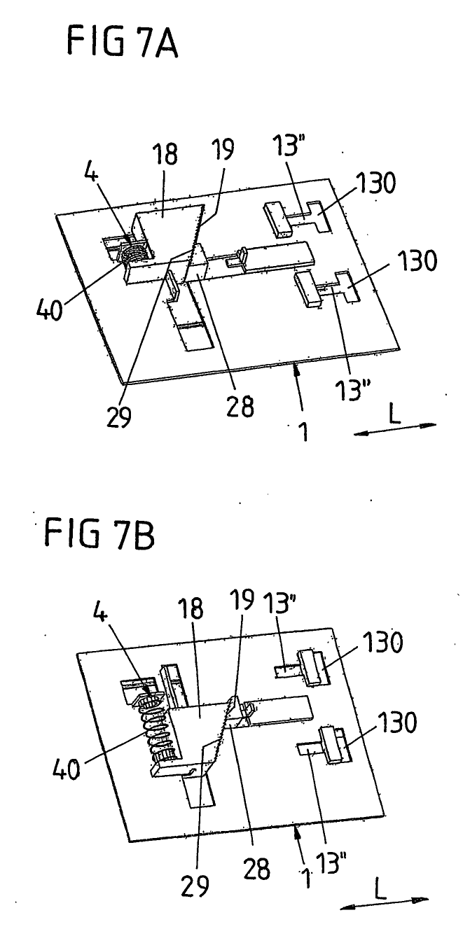

FIGS. 6a and 7a show a further modification of the deflection device of FIGS. 2a and 2b whereby here the socket 1 is not formed like a housing but like a plate and has longitudinal slits 13″ with thread-in regions 130 for guiding the slider 2. Furthermore the socket 1 and slider 2 interact with each other through inclined planes 18, 28 provided with a toothed region 19, 29 respectively, to enable a particularly finely adjusted locking of the slider 2 in different longitudinal positions on the socket 1. In accordance with the conversion of a movement released by the spring means 4 in the form of a pretensioned spring element 40 of the inclined planes 18 on the socket side into a longitudinal movement of the inclined plane 28 associated with the slider 2 the active direction of the spring means 4 is in this case perpendicular to the longitudinal direction L along which the guide slits 13″ extend for the slider 2 and along which the slider 2 is moved to compensate the cable length, as can be seen from FIGS. 6b and 7b in which the deflection device of FIGS. 6a and 6b is shown after the maximum cable length compensation through relaxation of the spring element 40 and corresponding displacement of the inclined planes 18, 28 as well as of the slider 2.

1-21. (canceled)

22. A deflection device for a motor vehicle window lifter with
a deflection element for guiding a traction means of the window lifter and
spring means for tightening the traction means,
whereby the deflection element is mounted movable on a socket and in order to tighten the traction means can be brought by the spring means mounted on the socket into a number of different positions on the socket and whereby the socket is fixable together with the deflection element and the spring means as one preassembled structural module on the window lifter, wherein
a fixing device is provided on the socket in order to fix the slider on the socket so long as the preassembled structural unit is not yet mounted on the window lifter wherein the fixing device is automatically releasable under the action of the traction means when the window lifter is brought into operation.

23. The deflection device according to claim 22, wherein the socket forms a housing.

24. The deflection device according to claim 22, wherein a guide is provided on the socket by which the deflection element is guided so that it can be brought into different positions in order to tighten the traction means.

25. The deflection device according to claim 22, wherein the deflection element is mounted displaceable on the socket.

26. The deflection device according to claim 25, wherein the slider and the deflection element are formed by separate parts which are connected together.

27. The deflection device according to claim 26, wherein the deflection element is fixed on the slider by a stepped bolt which engages through an opening in the slider.

28. The deflection device according to claim 24, wherein the slider is guided in the guide.

29. The deflection device according to claim 26, wherein the spring means are formed by at least one pretensioned spring element which engages on the slider and has the tendency to move same so that the traction means becomes taut.

30. The deflection device according to claim 22, wherein the fixing device is provided for a positive locking connection e.g. a detent connection.

31. The deflection device according to claim 22, wherein locking means are provided for locking the deflection element in different positions on the socket.

32. The deflection device according to claim 31, wherein the locking means are formed by positive locking means, more particularly by associated toothed regions.

33. The deflection device according to claim 32, wherein a toothed region is provided on one of the socket and on an insert part fitted therein.

34. The deflection device according to claim 26, wherein another toothed region is provided on the slider.

35. The deflection device according to claim 32, wherein the toothed regions are each provided on one of two associated inclined planes which are movable relative to each other.

36. The deflection device according to claim 31, wherein the locking means are locked during operation of the window lifter through the tension of the traction means.

37. The deflection device according to claim 36, wherein the locking means are releasable during relaxation of the traction means so that the deflection element is movable under the action of the spring means in order to tighten the traction means.

38. The deflection device according to claim 22, wherein it is set up and provided for use with a path window lifter with several guideways running parallel to each other for a follower of the window lifter.

39. A motor vehicle window lifter with
a drive
a traction means which can be driven by the drive and
a deflection device for the traction means, wherein
a deflection device according to claim 22.

40. The window lifter according to claim 39 wherein the window lifter is designed as a path window lifter with several guideways arranged side by side for at least one follower which is connected to the traction means.
